(19) United States
(12) Patent Application Publication
(10) Pub. No.: US 2006/0027250 A1
(43) Pub. Date: Feb. 9, 2006

(54) Device to catch and retrieve foam pellets

(76) Inventor: William O. Walters, Seattle, WA (US)

Correspondence Address: HARNESS, DICKEY & PIERCE, P.L.C., P.O. BOX 828, BLOOMFIELD HILLS, MI, 48303, US

(21) Appl. No.: 11/214,180

(22) Filed: Aug. 30, 2005

Related U.S. Application Data
(63) Continuation of application No. PCT/US04/04793, filed on Feb. 18, 2004.
(63) Continuation of application No. 10/779,500, filed on Feb. 14, 2004, now abandoned.
(60) Provisional application No. 60/448,136, filed on Feb. 20, 2003.
(60) Provisional application No. 60/448,135, filed on Feb. 20, 2003.
(60) Provisional application No. 60/448,134, filed on Feb. 20, 2003.

(51) Int. Cl. B08B 9/00

(52) U.S. Cl. 134/8; 15/3.5; 15/3.51

(57) ABSTRACT

An apparatus for the rapid loading and launching of foam pellets for tube cleaning. The apparatus uses a block configuration to allow gravity feed and rapid firing of pellets into tubes. The apparatus includes a hopper feeder attachment which is self adjusting during pellet jams.

This invention is continuation of a provisional application Nos. 60/448,134, 60/448,135, and 60/448,136 filed on Feb. 20, 2003.

### FIELD OF THE INVENTION

This invention relates to an apparatus for the cleaning of tubes. More particularly, to an attachments used in the cleaning of tubes using pellets and the retrieval and reuse thereof. Thereby reducing the cost and providing a savings from loss of down time and cost of recovery.

### BACKGROUND OF THE INVENTION

Industry has been looking for ways to clean hydraulic tubing that can replace the current method of vapor degreasing. A vapor degreaser is a large organic solvent still in which the solvent vapor condenses on and drains off the parts to be cleaned. Vapor degreaser systems are large, fixed installations which have a high purchase price and maintenance costs. Companies which use this method must also must obtain a yearly operating permit for there facilities from the Clean Air Agencies because of its potential air pollution and health risks. Replacing these vapor degreasers with a small, low-cost cleaning methods allow installations to consolidate sites and save money.

The pellet system is currently used to clean tubes at a relatively high rate in close quartered work cells. Tubes are bent into a large variety of complicated shapes and lengths. Pellets must be loaded, launched/retrieved and examined with a minimum of operator movement. Equipment which requires the operator to find and retrieve the spent pellet lowers productivity. Safety and noise consideration require that the pellets be fired into a containment device and that the noise be reduced to acceptable levels.

One method is to propel a polyurethane foam pellet through the tube using compressed air. The tight fitting foam scrubs the interior wall of the tube as it passes through. This is a widely used technique and there are at least 3 makers of pellets and pellet launching equipment worldwide. One component lacking from the vendors is equipment to capture and return the spent pellet to the operator so that it may be examined.

### SUMMARY OF THE INVENTION

The present invention provides an innovative, unique and useful alternative to commercially available foam pellet launchers for tube cleaning. This attachment provides a quick and efficient automatic loader and launcher for foam pellets. The invention comprises foam pellets that are gravity fed through a tubular magazine into a cylindrical vertical passageway in a block. This passageway is intersected at a right angle by a cylindrical horizontal passageway about the middle of the block. Below this horizontal passageway the vertical bore has a valved port. The valve releases compressed air into the passageway on a piloted air command. Free to slide in the horizontal passageway, a cylindrical shuttle is attached at one end to a pneumatic actuator. At its opposite end is a hole slightly larger than and aligning with the vertical bore when the shuttle is extended. Also at this end, the shuttle has a pin through it that extends through slots on opposite sides of the block. This pin can contact a spring loaded release lever and rotate it about an axle through the block. The release lever straddles the block and has a projection that protrudes through a small hole intersecting the vertical passageway in the block previously described.

One aspect of the present invention regards a foam pellet catcher and retriever having a transfer tube that receives the foam pellet from a cleaned tube. The transfer tube transfers the foam pellet to a chamber under air-pressure. The foam pellet remains in the chamber until the air-pressure is removed at which time the foam pellet then exits the chamber.

Another aspect of the present invention regards a method of retrieving spent cleaning pellets used in a tube cleaning process by introducing the pellets via a jet stream into one end of the tube. A fitting is placed over the other end of the tube to allow the pellets to pass into a transfer tube. Air pressure creates a jet stream that pushes the foam pellet to the other end of the transfer tube. A chamber that is attached to that end of the transfer tube traps the foam pellet. Stopping the jet stream allows the pellets to exit the chamber.

Another aspect of the invention is a hopper attachment used to rapidly load pellet launchers. Additionally the attachment self corrects jammed pellets, thereby reducing the time, cost, and providing a savings from loss of down time and cost of recovery.

Another aspect of the invention comprises a fitting with a flexible seal opening to receive the (exit) end of the tube being cleaned, a return tube to carry the pellet back to the operator where a receiver captures the pellet, separates it from the air stream and releases it to the operator.

Each aspect of the present invention provides an innovative, unique and useful attachment to commercially available foam pellet launchers for tube cleaning. This attachment speeds up the process for retrieval and provides productivity improvements because the pellet method allows the user to go from the current batch-processing method to one-piece processing in work cells.

Additional embodiments and advantages of the present invention will be apparent from the following description and the appended claims when considered with the accompanying drawings.

### BRIEF DESCRIPTION OF THE DRAWINGS

FIG. 1 shows an embodiment of the invention;

FIG. 2 shows an exploded view of some of the major components of the invention;

FIG. 3 shows a detailed cross-sectional view of the invention with its release lever in the locked position; and

FIG. 4 shows a detailed cross-sectional view of the invention with its release lever in the unlocked position

FIG. 5 shows a perspective view of an embodiment of a foam pellet catcher and retriever, according to the present invention;

FIG. 6 shows a cut away of the receiver, according to the present invention; and

FIG. 7 shows a cross-sectional view of an embodiment of the retrieval chamber of FIG. 6;

FIG. 8 shows a cross-sectional view of an embodiment of the retrieval chamber of FIG. 6;

FIG. 9 shows another embodiment of a foam pellet catcher;

FIG. 10 shows a collection chamber; and

FIG. 11 shows another detail of the collection chamber;

### DETAILED DESCRIPTION OF THE INVENTION

Reference will now be made in detail to the present preferred embodiment of the invention, an example of which is illustrated in the accompanying drawings. While the invention will be described in connection with a preferred embodiment, it will be understood that it is not intended to limit the invention to that embodiment. On the contrary, it is intended to cover all alternatives, modifications, and equivalents as may be included within the spirit and scope of the invention defined in the appended claims.

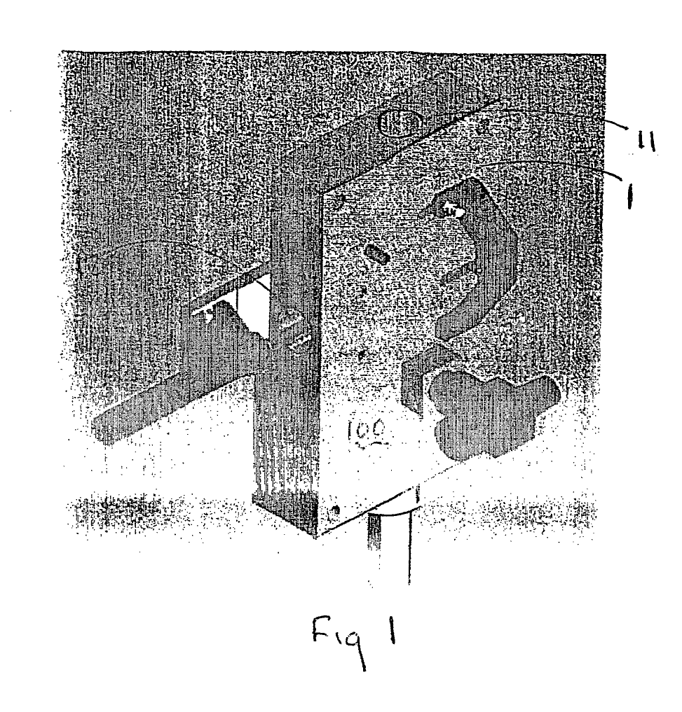

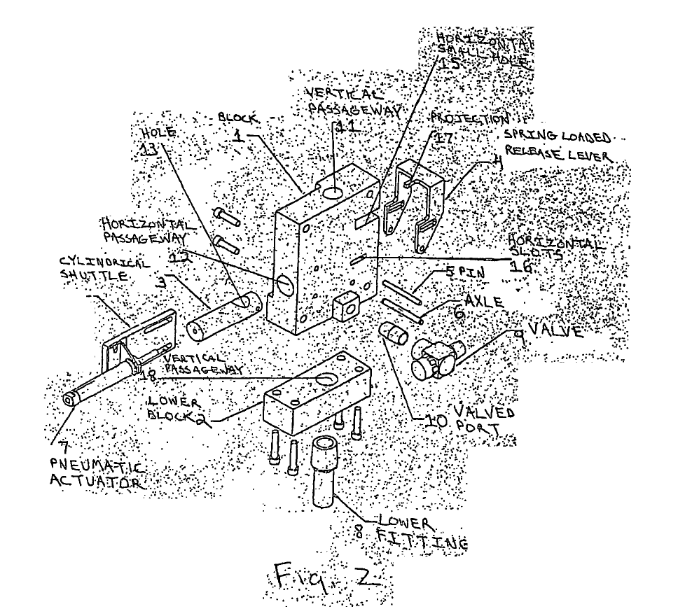

Referring to FIGS. 1, and 2, the device for automatically loading and firing foam pellets (100) comprises a block (1) that contains a cylindrical vertical passageway (11). Foam pellets are gravity fed through a tubular magazine (not shown) into said cylindrical vertical passageway (11) of said block (1). This passageway is intersected at a right angle by a cylindrical horizontal passageway (12) about the middle of the block (1). Below this horizontal passageway (12) the vertical bore has a valved port (10). The valve (9) releases compressed air into the passageway (11) on a piloted air command. Free to slide in the horizontal passageway, a cylindrical shuttle (3) is attached at one end to a pneumatic actuator (8). At its opposite end is a hole (13) slightly larger than and aligning with the vertical bore. When the shuttle (3) is extended the shuttle (3) has a pin (5) through it that extends through slots (16) on opposite side of the block (1). This pin (5) contacts a spring loaded release lever (4) and rotates it about an axle (6) through the block (1). The release lever (4) straddles the block (1) and has a projection (17) that protrudes through a small hole (15) intersecting the vertical passageway (11) of the block (1) previously described.

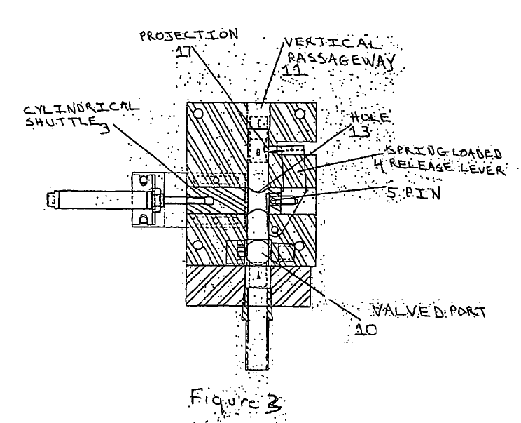

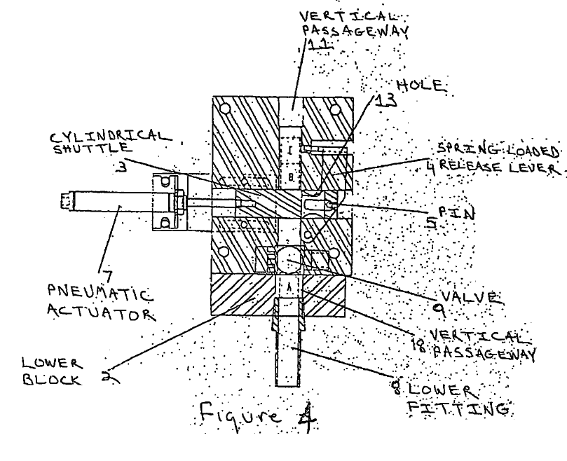

Referring to FIG. 3, operation starts with one pellet (a) in the chamber below the air injection port (11). The shuttle (3) is in the retracted position, a hole (13) is aligned with the vertical passageway (11). The pin (5) on the shuttle (3) does not contact the lever (4) allowing the projection on the lever (4) to jam the lowest pellet (b) above the shuttle (3) in the vertical passageway (11). No pellets can fall through the hole (13) in the shuttle (3) to the bottom. Referring to FIG. 4, on triggering, the shuttle (3) is pushed into the forward position by the actuator (8), first blocking the vertical passageway (11), then as it moves farther, the pin (5) pushing the release lever (4) back releasing the pellets. The pellets drop together until the lowest one (b) rests on top of the shuttle (3). Once the shuttle (3) is fully forward, a pneumatic actuator (7) on the shuttle (3) detects this condition and opens the piloted valve (10). The compressed air behind pellet (a) forces it through the lower block (2) that contains a cylindrical vertical passageway (18) that is aligned with the vertical passageway of block (1). The lower block also contains four (4) openings located at the corners of the lower block (2) for the insertion of bolts (11). Attached to the lower block (2) is the lower fitting (9) that the flexible hose (not shown) is attached, acting as the gun barrel. The pellet exits a muzzle at the other end of the hose (not shown) and is propelled through the tube being cleaned. The shuttle (3) remains in the forward position and air continues to flow as long as the trigger is held down.

When the trigger is released the shuttle (3) moves rearward but before the hole (13) in it realigns with the vertical passage (11), the projection on the release lever (4) jams the pellet (c) immediately above the one resting on the shuttle (3). As the shuttle (3) continues to move to the rear position, the hole (13) comes into alignment, and a single pellet (b) falls into the lower portion of the block (2). The device is now in the starting position again.

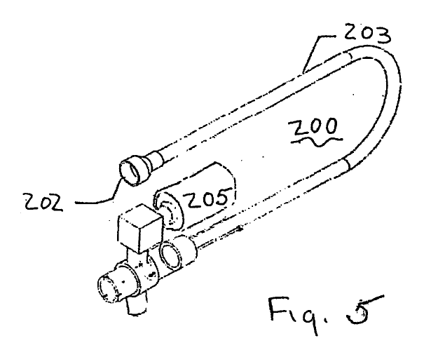

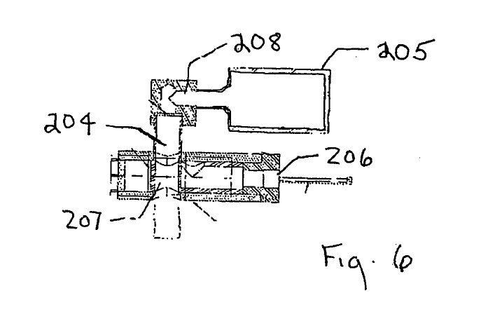

FIG. 5 shows a perspective view of a foam pellet catcher and retriever (“FPCR”) 200. The FPCR 200 includes a bell fitting 202, transfer tube 203, chamber 204 and a muffler 205. The chamber 204 includes an input opening 206 and an output opening 207, as shown in FIG. 6 and FIG. 7. The chamber 204 is also known as a collection chamber. The muffler 205 is connected to the chamber 204 at opening 208.

A slide valve 209 is positioned within the chamber 204. In operation, air pressure from the jet stream holds the slide valve in position 1. As the jet stream continues, air escapes through opening 203 and out the muffler 205. The pellet is trapped in chamber 204. When the air pressure is released the valve is released and moves to position 2 and thus allowing the foam pellet to fall through opening 207.

The collection chamber 204 is typically constructed of metal or plastic. In a preferred embodiment, the bell fitting 202 is a standard bell fitting and is connected to one end of the transfer tube 203. The transfer tube 203 may be bent into a large variety of complicated shapes and lengths and is typically made of copper or other bendable material that can withstand high air-pressure. Typically, the bell fitting 202 has a flexible seal opening to receive the exit end of a tube being cleaned and is connected to the transfer tube by clamps; however other types connections may be used provide they are non-obstructive. The other end of the transfer tube 103 is connected to the input opening 206 of the chamber 204 and is connected to the transfer tube 203 by clamps; however other types connections may be used provide they are non-obstructive. The muffler 205 is connected to output opening 208 of the chamber 204. Typically, the muffler 205 is a standard auto glass packed muffler; however other types of mufflers know in the art may be use. The muffler 205 may be connected to output opening 208 by screwing the muffler 205 into the output opening 108, by soldering the muffler 205 to the output opening 208 or other attachment methods known in the art. The muffler 205 is used to control and reduce noise to acceptable levels for safety reasons because the present invention is used to clean tubes at a relatively high rate in close quartered work cells.

FIG. 6 shows a plan view of an embodiment of a chamber 204, according to the present invention. As shown in FIG. 2, a spent pellet 208 enters the chamber 204 through the input opening 206. In a preferred embodiment the spent pellet 210 emerges from a cleaned tube (not shown) and is propelled into the transfer tube 203 via the bell fitting 202 under air-pressure. The spent pellet 210 is then transferred from the transfer tube 203 into the chamber 204 through the input opening 206. In FIG. 3, the slide valve 209 moves to position 1 within the chamber 204 as long as there is air-pressure from the transfer tube 203. As shown in FIG. 4, when the air-pressure is removed, the slide valve 209 in the chamber 204 moves to position 2. The valve moves and the spent pellet 210 fall through the output opening 207 of the chamber 204, Typically, the spent pellet is a foam pellet made of polyurethane. The spent pellet 208 may then be examined by an operator, at which time appropriate action can be taken.

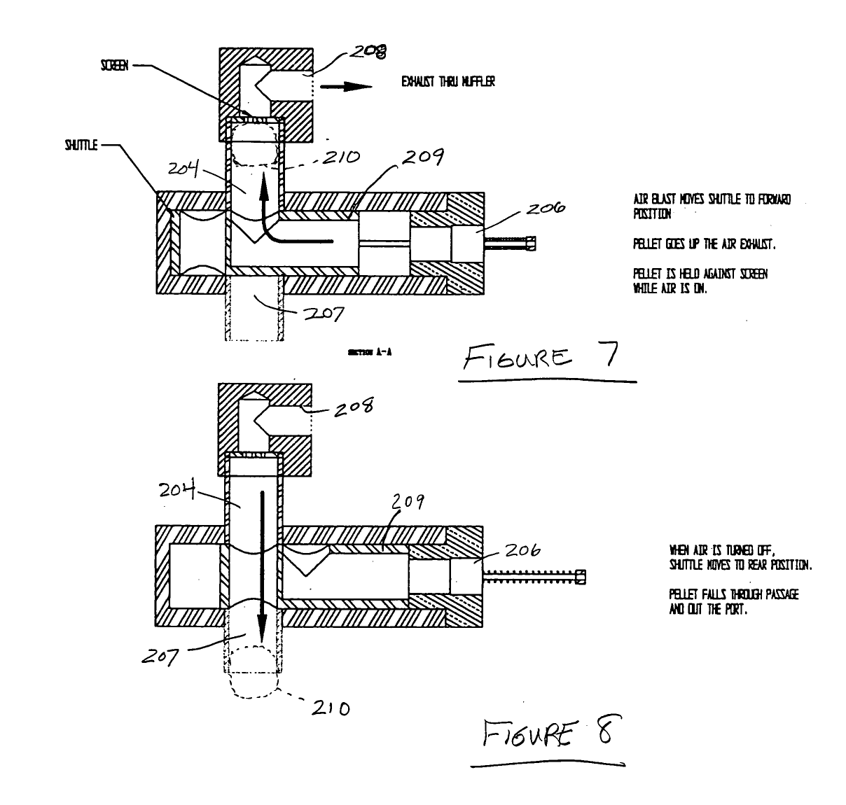

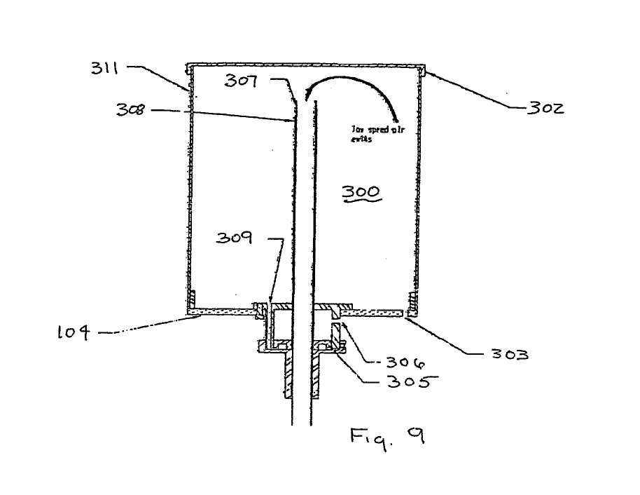

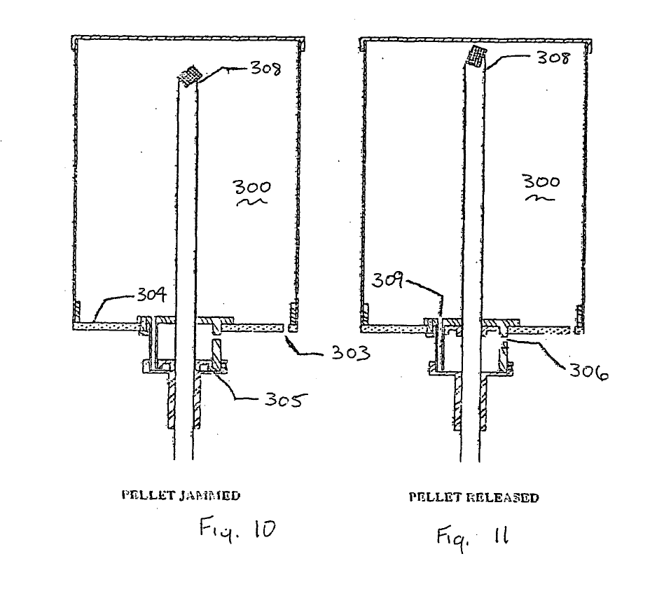

FIGS. 7-9 shows an embodiment of an attachment for fast loading foam pellets. This invention is comprised of a hopper made of a cylindrical container (300) about 8 inches high with a removable top (302) secured with buckles to the outer wall (311). There are four air inlets (303) around the periphery of the container floor (304) equally spaced close to the inside wall. These direct air upward and serve to circulate the foam pellets in the container. Mounted in the center of the container floor is a cylinder piston device (305) which passes through the floor (304). A thin-walled vertical tube (307) passes through this cylinder and extends into the container to approximately two inches from the cover. Another tube (308), slightly larger is slipped over the previous one (307) and is attached to the piston (305) inside the bottom cylinder. The outside tube (108) is free to slip over the inner one (307) and is cut at a 45 degree angle at the top. The tube lengths are such that when the outer tube (308) and its attached piston (305) are at the lower end of travel, the tops of both tubes (307 and 308) are at the same height.

The cylinder piston (305) device in the floor (304) of the container has several air ports. One of these (309) carries air from the interior of the container (300) to a space below the piston (306). The space above the piston (306) is vented to the outside via several radial ports (310) in the cylinder wall (311). A small port (not shown) at the top of the cylinder also vents to the atmosphere.

In operation, three to four hundred foam pellets are placed into the container (300) and the cover (302) is attached. Air entering from the ports in the floor (304) flows out through the center tube (307). The air stream carries pellets into the center tube (307) where they pass down the tube (307) and stack up for loading into a pellet launcher. Below the container floor (304), the tube (307) has ventilation ports in the tube wall all along its length to allow the air to escape. Pellets passing into the tube will jam at the top opening if they are not oriented properly (FIG. 2). When a jam occurs, the tube (307) is partially blocked, causing the pressure to rise in the container (300). This increase in pressure is communicated to the underside of the piston (305) through one set of ports (309). This causes the piston (305) to rise, lifting the outer tube (308) and righting the jammed pellet. Once air is flowing in the tube again, the outer tube (308) falls to its resting position.

The cylinder piston (305) device serves an additional role as a pressure relief valve. If pellets are not used fast enough by the launcher, they stack up in the exit tube (307). Although the tube (307) is vented, eventually the pellets will back up into the region of the tube that is inside the container. When this happens, the tube is again blocked and the piston (305) raises past the radial vent ports and the air escapes.

The foregoing description is provided to illustrate the invention, and is not to be construed as a limitation. Numerous additions, substitutions and other changes can be made to the invention without departing from its scope as set forth in the appended claims.

What is claimed is:

1. An apparatus for the loading and launching of pellets used in tube cleaning comprising:
a block having a cylindrical vertical passageway therethrough;
a horizontal passageway along the center axis of said block and intersecting said vertical passageway at a right angle;
a valve port located along the vertical axis of the vertical passageway and below the horizontal passageway of said block;
a valve attached to said valve port for delivering compressed air on demand;
a pneumatic actuator within said horizontal passageway;
a cylindrical shuttle attached to said actuator and having the ability to freely move along said horizontal shuttle to a retracted and extended position;
a pin attached perpendicular to the opposite end of said shuttle;
a lower block attached to said block by bolts having a cylindrical vertical passageway therethrough which aligns with the vertical passageway of said block
a lower fitting attached to vertical passageway of the lower block;
a spring loaded release lever affixed to said block having a pin which extends through slots located on opposite sides of said block;
an axle affixing said spring loaded release lever to said block and
said release lever straddling the block and having a projection that extends through a hole intersecting the vertical passageway of the block.

2. A device for automatically loading and firing foam pellets as recited in claim 1 wherein said cylindrical shuttle further comprising:
a hole at the opposite end of said shuttle that is larger than and in align with the vertical passageway of the block when said shuttle is extended;
a pin attached perpendicular to and on the opposite end of said shuttle that extends through horizontal slots of the block; and
an air threshold sensor attached to the end of said shuttle to open the piloted valve when the shuttle is fully forward.

3. A device for automatically loading and firing foam pellets as recited in claim 1 wherein said pneumatic actuator includes a means for retracting and extending said cylindrical shuttle in the horizontal passageway of said block and means to contact said release lever.

4. A device for automatically loading and firing foam pellets as recited in claim 1 wherein said spring loaded release lever includes a means for releasing and restricting the movement of foam pellets in said block.

5. A device for loading and firing foam pellet as recited in claim 4 wherein said spring loaded release lever further comprising:
a pin which projects through a small hole intersecting the vertical passageway of said block;
said pin forcibly contacts the foam pellets in the vertical passageway of said block

6. An apparatus for feeding pellets used in tube cleaning comprising:
a cylinder having a floor and a removable top;
a first tube exiting through the cylinder floor;
a second tube located within said first tube;
a cylinder end cap around the circumference of said second tube and engaged with said cylinder floor; and
a piston encircling said first tube and said second tube resting on said piston.

7. The apparatus as recited in claim 6 wherein said cylinder floor has a plurality of ports around its periphery allowing high pressure air to enter the cylinder.

8. The apparatus as recited in claim 7 wherein said first tube is located along the center axis of said cylinder.

9. The apparatus as recited in claim 8 wherein one of said plurality of ports communicates the increase in air pressure in said cylinder to the piston causing it to push said second tube along said first tube whereby a jammed pellet is repositioned in said first tube.

10. The apparatus as recited in claim 9 wherein said second tube has top and bottom ends and whereby said top end has an opening cut at a 45 degree angle.

11. A method of loading cleaning pellets used in a tube cleaning process and correcting said pellet alignment comprising the steps of:
(a) introducing said pellets in a cylinder;
(b) providing a first and second tube and whereby said first tube is deposed in said cylinder;
(c) attaching a piston to said second tube and encircling said first tube; and
(d) introducing a jet stream into said cylinder and allowing said pellets to exit through said first tube.

12. The method as recited in claim 11 wherein said cylinder further comprises a removable top and a floor.

13. The method as recited in claim 12 wherein said cylinder floor has a plurality of ports around its periphery allowing said jet stream to enter the cylinder.

14. The method as recited in claim 13 wherein said first tube is located along the center axis of said cylinder and exits through the cylinder floor.

15. The method as recited in claim 14 wherein said second tube has top and bottom ends and whereby said top end has an opening cut at a 45 degree angle.

16. The method as recited in claim 15 wherein one of said plurality of ports communicates the increase in air pressure in said cylinder to the piston causing it to push said second tube along said first tube whereby a jammed pellet is repositioned in said first tube.

17. An apparatus for the retrieval and inspection of a spent pellet used in tube cleaning comprising:
a transfer tube comprising a first end and a second end;
said first end connected to said tube; and
a chamber comprising an input opening, output opening and an exit opening;
said input opening attached to said second end of said transfer tube;
wherein when said spent pellet enters said first end of said transfer tube under air-pressure from said tube, said spent pellet is transferred to said chamber through said input opening of said chamber;
wherein said spent pellet exits said output opening of said chamber when said air-pressure is removed.

18. The apparatus of claim 17, wherein said transfer tube further comprises a fitting connected to said first end of said transfer tube and said tube.

19. The apparatus of claim 18, wherein said fitting comprises a bell fitting.

20. The apparatus of claim 17, wherein said chamber comprises a slide valve.

21. The apparatus of claim 20, wherein when said spent pellet enter into said chamber and said air pressure moves said slide valve to a first position trapping said pellet and allowing said air pressure to pass through said exit opening.

22. The apparatus of claim 17, wherein said chamber comprises a collection chamber.

23. The apparatus of claim 17, wherein said chamber further comprises a pass through muffler connected to said exit opening of said chamber.

24. The apparatus of claim 17, wherein said spent pellet comprises a foam pellet.

25. The apparatus of claim 17, wherein said spent pellet comprises a polyurethane foam pellet.

26. A method of retrieving spent cleaning pellets used in a tube cleaning process comprising the steps of:
(a) introducing said pellets via a jet stream into one end of said tube;
(b) attaching a fitting over the other end of said tube allowing said pellets to pass to a transfer tube;
(c) providing a slide valve in a chamber attached to said transfer tube and collecting said pellets; and
(d) stopping said jet stream and allowing said pellets to exit said chamber.
